(19) United States
(12) Patent Application Publication
(10) Pub. No.: US 2015/0022450 A1
(43) Pub. Date: Jan. 22, 2015

(54) MOUSE

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: PING LIU, Shenzhen (CN); YA-BIN LIU, Shenzhen (CN)

(21) Appl. No.: 14/335,287

(22) Filed: Jul. 18, 2014

(30) Foreign Application Priority Data
Jul. 22, 2013 (CN) 2013103072492

(51) Int. Cl. G06F 3/0354

(52) U.S. Cl. CPC G06F 3/03543
USPC 345/163

(57) ABSTRACT

A mouse includes a base and a cover. The base includes a bottom panel with a sensor. The cover includes a sensing area. A reference point and a number of sensing points are located on the sensing area. A displacement of a mouse arrow on a screen is defined as a displacement of the sensing points from the reference point. The sensor senses light from the sensing area. When one of the sensing points is shielded, the sensor sends an operating signal to a control module of an electronic device for generating a displacement of the mouse arrow on the screen corresponding to the shielded sensing point.

### FIELD

The present disclosure relates to input devices, and more particularly to a mouse.

### BACKGROUND

Most computer systems, such as portable computers and desktop computers, receive input from a user via an input device such as a mouse. As is generally well known, the mouse allows a user to move an input pointer and to make selections in a graphical user interface (GUI). The mouse generally includes a trackball, which is located on an underside of the mouse and rolls when the mouse moves. Movement of the trackball is translated into signals that the computer system can use to move a mouse arrow on a screen. An optical sensor may alternatively be used to track the movement of the mouse. The mouse also includes one or two mechanical buttons for data selection and command execution.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a mouse.

FIG. 2 is similar to FIG. 1, but viewed from a different angle.

FIG. 3 is an assembled view of the mouse of FIG. 1.

FIG. 4 is a cross-sectional view of FIG. 3, taken along line IV-IV.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

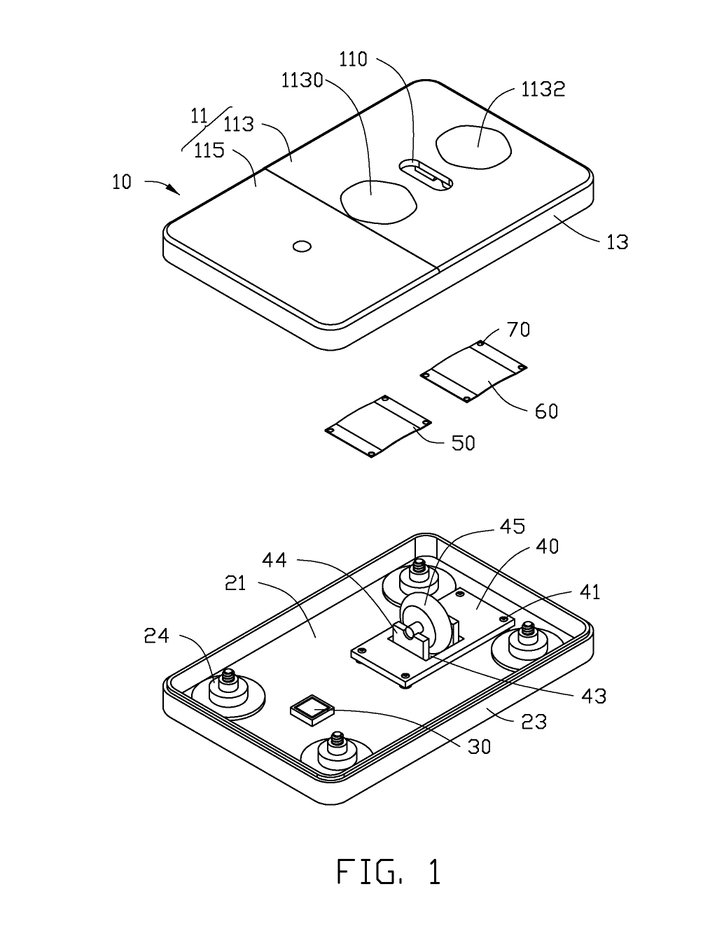

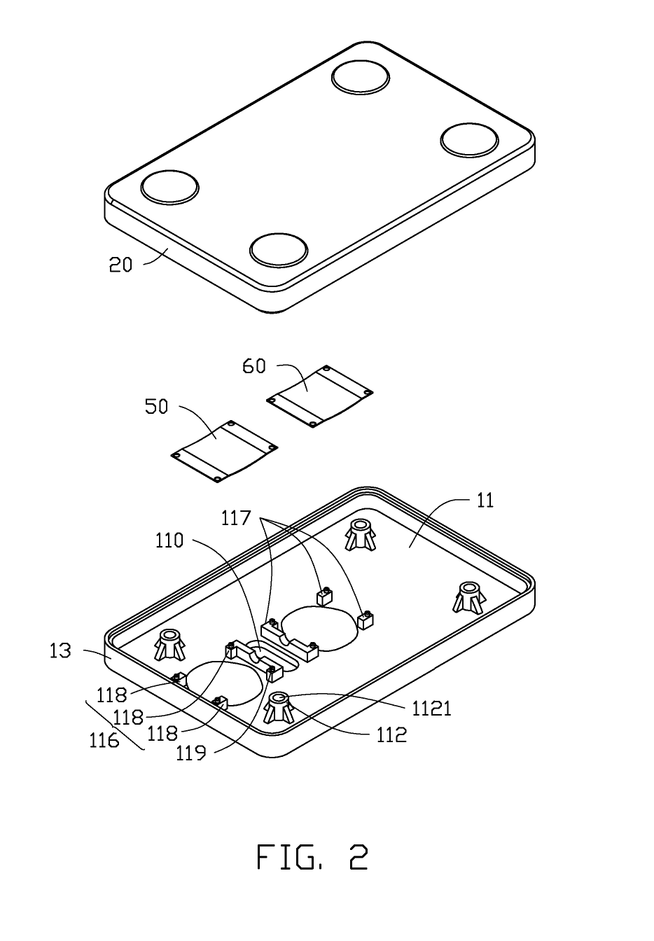

FIGS. 1-2 illustrate an embodiment of a mouse. The mouse comprises a base 20, and a cover 10 attached to the base 20.

The base 20 comprises a bottom panel 21 and a plurality of side panels 23 extending from edges of the bottom panel 21. A plurality of securing portions 24, such as four securing posts, protrudes from the bottom panel 21. A sensor 30 and a circuit board 40 are located on the bottom panel 21. In at least one embodiment, the sensor 30 is a photoreceptor. The sensor 30 is electrically connected to the circuit board 40. A plurality of mounting holes 41 is defined in corners of the circuit board 40. The circuit board 40 defines an opening 43, and two positioning panels 44 are located at opposite sides of the opening 43. In at least one embodiment, the two positioning panels 44 are substantially parallel to each other. A roller 45 is located between the two positioning panels 44.

A first sensing piece 50 and a second sensing piece 60 can be attached to the circuit board 40 to be connected to a control module (not shown) of an electronic device. In at least one embodiment, the electronic device can be a computer, and the first sensing piece 50 and the second sensing piece 60 can be deformable. Each of the first sensing piece 50 and the second sensing piece 60 define four fixing holes 70. The first sensing piece 50 can be used to send a first signal to the control module, so that the control module can control a movement of a mouse arrow on a screen (not shown) according to the first signal. The second sensing piece 60 can be used to send a second signal to the control module, so that the control module can control the movement of the mouse arrow of the screen according to the second signal.

The cover 10 comprises a top panel 11, and a plurality of side panels 13 extending from edges of the top panel 11. A plurality of mounting portions 112 corresponding to the plurality of securing portions 24 protrudes from the top panel 11. Each mounting portion 112 defines a mounting hole 1121. The top panel 11 comprises an operating area 113 and a sensing area 115. In one embodiment, the sensing area 15 is transparent, and the sensor 30 can be used to sense light from the sensing area 15.

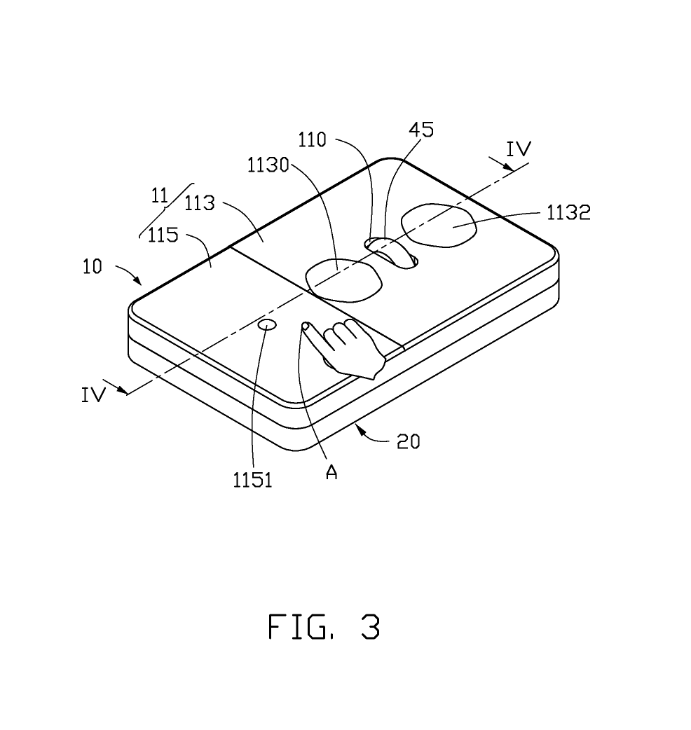

The operating area 113 comprises a first pressing portion 1130 and a second pressing portion 1132. Each of the first pressing portion 1130 and the second pressing portion 1132 can be concave relative to the top panel 11. A first mounting assembly 116 and a second mounting assembly 117 surround the first pressing portion 1130 and the second pressing portion 1132, respectively. Each of the first mounting assembly 116 and the second mounting assembly 117 comprise a plurality of protruding blocks 118. A fixing post 119 is located on each of the plurality of protruding blocks 118. A through hole 110 is defined between the first pressing portion 1130 and the second pressing portion 1132 for allowing the roller 45 to extend there through. When the first pressing portion 1130 is pressed against the first sensing piece 50, the first sensing piece 50 sends the first signal to the control module. When the second pressing portion 1132 is pressed against the second sensing piece 60, the second sensing piece 60 sends the second signal to the control module. A reference point 1151 (shown in FIG. 3) is located on the sensing area 115. A plurality of sensing points is located on the sensing area 15.

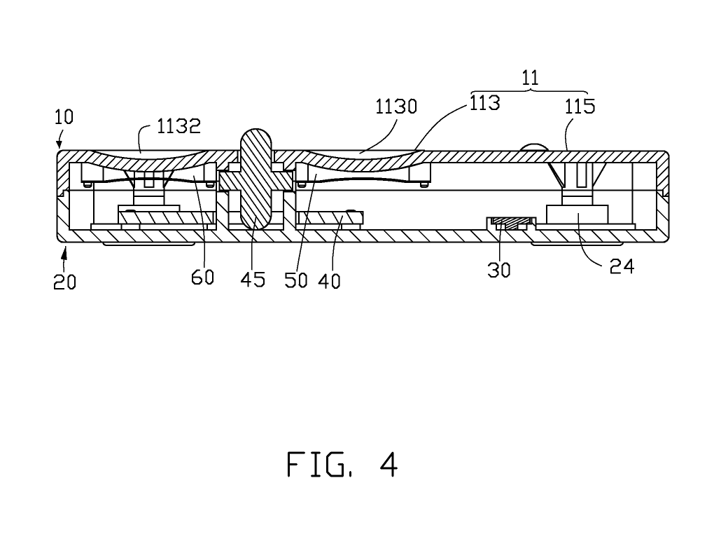

FIGS. 3-4 illustrate assembly of the mouse. The fixing posts 119 of the first mounting assembly 116 extend through two mounting holes 41 of the circuit board 40 and the fixing holes 70 of the first sensing piece 50 to secure first sensing piece 50 to the base 20 and the cover 10. The fixing posts 119 of the second mounting assembly 117 extend through the other two mounting holes 41 of the circuit board 40 and the fixing holes 70 of the second sensing piece 60 to secure the second sensing piece 60 to the base 20 and the cover 10. The plurality of securing portions 24 is received in the plurality of mounting holes 1121, to secure the base 20 to the cover 10.

When the first pressing portion 1130 is pressed against the first sensing piece 50, the first sensing piece 50 sends the first signal to the control module, and the control module controls the movement of the mouse arrow on the screen according to the first signal. When the second pressing portion 1132 is pressed against the second sensing piece 60, the second sensing piece 60 sends the second signal to the control module, and the control module controls the movement of the mouse arrow on the screen according to the second signal. When a finger is pressed on a sensing point A of the sensing area 115, the sensor 30 cannot sense light from the sensing point A, so the sensor 30 sends an operating signal to the control module. A displacement of the mouse arrow on the screen is generated corresponding to the operating signal. In one embodiment, the displacement of the mouse arrow correlates to a displacement of the sensing point A from the reference point 1151.

Even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure. The embodiments described herein are illustrative only and should not be read to limit the following claims.

What is claimed is:

1. A mouse comprising:
a base comprising a bottom panel;
a sensor located on the bottom panel; and
a cover comprising a sensing area;
the sensing area comprising a reference point and a plurality of actual sensing points surrounding to the reference point;
a displacement defined each of the plurality of actual sensing points and the reference point;
wherein the sensor is configured to sense lights from the sensing area, and when one of the plurality of actual sensing points is shielded, the sensor is configured to send an operating signal to a control module of an electronic device, for allowing the control module to generate a corresponding displacement on a screen of the electronic device according to the displacement defined by the one of the plurality of actual sensing points and the reference point.

2. The mouse of claim 1, wherein the sensing area is transparent.

3. The mouse of claim 1, wherein the cover further comprises an operating area connected to the sensing area, the operating area comprises a first pressing portion, a first sensing piece is located below the first pressing portion, and the first sensing piece is configured to send a first signal to the control module by the first pressing portion, for allowing the control module to control a first movement of a mouse arrow on a screen of the electronic device according to the first signal.

4. The mouse of claim 3, wherein the operating area further comprises a second pressing portion, a second sensing piece is located below the second pressing portion, and the second sensing piece is configured to send a second signal to the control module by the second pressing portion, for allowing the control module to control a second movement of the mouse arrow on the screen according to the second signal.

5. The mouse of claim 4, wherein a circuit board is located on the bottom panel, and the first sensing piece and the second sensing piece are secured to the circuit board.

6. The mouse of claim 5, wherein a first mounting assembly is located on the cover, the first mounting assembly comprises a plurality of protruding blocks, and the plurality of protruding blocks extends through the first sensing piece to engage in the circuit board.

7. The mouse of claim 5, wherein a roller is located on the bottom panel, a through hole is defined in the cover, and the roller extends through the through hole and exposed out of the cover.

8. The mouse of claim 7, wherein the circuit board defines an opening, and the roller is located in the opening.

9. The mouse of claim 8, wherein two parallel positioning panels are located on opposite sides of the opening, and the roller is located between the two parallel positioning panels.

10. A mouse comprising:
a base comprising a bottom panel;
a sensor located on the bottom panel; and
a cover comprising a sensing area and an operating area connected to the sensing area; the sensing area comprising a reference point and a plurality of actual sensing points surrounding to the reference point;
a displacement defined each of the plurality of actual sensing points and the reference point;
a first sensing piece located below the first pressing portion;
wherein the sensor is configured to sense lights from the sensing area, and when one of the plurality of actual sensing points is shielded, the sensor is configured to send an operating signal to a control module of an electronic device, for allowing the control module to generate a corresponding displacement on a screen of the electronic device according to the displacement defined by the one of the plurality of actual sensing points and the reference point, and the first sensing piece is configured to send a first signal to the control module by the first pressing portion, for allowing the control module to control a first movement of a mouse arrow on a screen of the electronic device according to the first signal.

11. The mouse of claim 10, wherein the sensing area is transparent.

12. The mouse of claim 10, wherein the operating area further comprises a second pressing portion, a second sensing piece is located below the second pressing portion, and the second sensing piece is configured to send a second signal to the control module by the second pressing portion, for allowing the control module to control a second movement of the mouse arrow according to the second signal.

13. The mouse of claim 12, wherein a circuit board is located on the bottom panel, and the first sensing piece and the second sensing piece are secured to the circuit board.

14. The mouse of claim 13, wherein a first mounting assembly is located on the cover, the first mounting assembly comprises a plurality of protruding blocks, and the plurality of protruding blocks extends through the first sensing piece to engage in the circuit board.

15. The mouse of claim 13, wherein a roller is located on the bottom panel, a through hole is defined in the cover, and the roller extends through the through hole and exposed out of the cover.

16. The mouse of claim 15, wherein the circuit board defines an opening, and the roller is located in the opening.

17. The mouse of claim 16, wherein two parallel positioning panels are located on opposite sides of the opening, and the roller is located between the two parallel positioning panels.

18. The mouse of claim 16, wherein the cover comprises a mounting post, a mounting hole is defined in the mounting post, and a securing portion is located on the bottom panel and is engaged in the mounting hole to secure the cover to the base.
